(19) United States
(12) Patent Application Publication
(10) Pub. No.: US 2021/0004774 A1
(43) Pub. Date: Jan. 7, 2021

(54) METHOD AND SYSTEM PROVIDING INTEROPERABILITY BETWEEN BLOCKCHAIN ECOSYSTEMS

(71) Applicant: Tata Consultancy Services Limited, Mumbai (IN)

(72) Inventor: Vivekanand RAMGOPAL, Chennai (IN)

(73) Assignee: Tata Consultancy Services Limited, Mumbai (IN)

(21) Appl. No.: 16/760,515

(22) PCT Filed: Nov. 1, 2018
(86) PCT No.: PCT/IB2018/058576

§ 371 Date: Apr. 30, 2020

(30) Foreign Application Priority Data
Nov. 2, 2017 (IN) 201721037068

(51) Int. Cl. G06Q 20/06; G06Q 20/10; H04L 9/06

(52) U.S. Cl. CPC G06Q 20/06; G06Q 20/10; H04L 2209/38; H04L 2209/56; H04L 9/0643

(57) ABSTRACT

This disclosure relates generally to a system and method to interoperability between two or more independent ecosystems. Wherein the first ecosystem comprises a blockchain platform. The system identifies a smart contract of the blockchain platform, a set of protocols of the second ecosystem, and a format of a message of the second ecosystem. The identified smart contract, the identified set of protocols, the identified format of the message and a meta-data driven service orchestration for the transaction are analyzed by the system. Further, the system invokes at least one application programming interface (API) based on the analysis of the smart contract of the first ecosystem, the set of protocols and the format of the message of the second ecosystem, and the metadata driven service orchestration for the transaction. Finally, the system is enabled to transmit the at least one transaction between the first ecosystem and the second ecosystem.

### PRIORITY

This application is a U.S. National Stage Filing under 35 U.S.C. § 371 and claims priority from International Application No. PCT/IB2018/058576, filed on Nov. 01, 2018, which application claims priority under 35 U.S.C. § 119 from Indian Application No. 201721037068, having priority date Nov. 02, 2017. The entire contents of the aforementioned application is incorporated herein by reference.

### TECHNICAL FIELD

The disclosure herein generally relates to a field of blockchain technology and, more particularly, to an interoperability among two or more blockchain platforms in a blockchain enterprise environment.

### BACKGROUND

Various Blockchain or Distributed Ledger Technology (DLT) platforms today are fostering partnerships between multiple organizations in a value chain, eliminating redundancies and improving efficiencies. It is being explored in areas as varied as digital identities and registries, payments, clearing and settlement and information exchanges. Organizations are interested in integrating blockchain technology into their business processes. The emergence of blockchain technology is closely associated with the existence of Bitcoin digital asset, as it is this technology that underpins to determine and maintain bitcoin transactions in a distributed ledger. However, as the blockchain technology evolved, its benefits were recognized by a wider set of industries beyond payments and hence more blockchain platforms such as Linux Hyperledger Fabric, Ethereum and the like were developed. These multiple platforms operated independently with their platform specific design mechanism and protocols. Thus, posing difficulty for business to interoperate between heterogeneous blockchain platforms based on suitability to a business process and availability of the ecosystem or regional dominance in a specific market, to benefit from. Thus, sending and receive data from one another is practically not possible. Current methods for interoperability among multiple blockchains lack of solutions that can work with multiple blockchains based on the suitability to a business process.

Thus, solutions or platforms that enable communication between multiple blockchain deployments to co-exist and interoperate between them will be appreciated.

### SUMMARY

Embodiments of the present disclosure provides technological improvements as solutions to one or more of the above-mentioned technical problems recognized by the inventors in conventional systems. For example, in one embodiment, a method and system providing a gateway that enables interoperability between two or more independent ecosystems in a block chain environment.

In one embodiment, a method provides interoperability between two or more independent ecosystems. Wherein the two or more independent ecosystems comprise of at least one of a traditional messaging network, a first blockchain platform at one end and a second blockchain platform at another end. Herein, the method comprising one or more steps of transmitting at least one transaction from a first ecosystem to a second ecosystem, wherein the first ecosystem comprises a blockchain platform, identifying a smart contract of the blockchain platform for interoperability with the second ecosystem, identifying a set of protocols of the second ecosystem to connect with the second ecosystem, identifying a format of a message of the second ecosystem to transmit to the second ecosystem, analyzing the identified smart contract, the identified set of protocols, the identified format and a meta data driven service orchestration for the transaction, invoking at least one application programming interface (API) based on the analysis of smart contract of the first ecosystem, the set of protocols and formats of the second ecosystem, and the metadata driven service orchestration for the transaction and completing the at least one transaction between the first ecosystem and the second ecosystem. Further herein, the method comprising receiving a response from the second ecosystem and processing the received response from the second ecosystem to complete the transaction within the first ecosystem.

In another embodiment, a system is configured to provide interoperability between two or more independent ecosystems. The system comprising at least one memory storing a plurality of instructions and one or more hardware processors communicatively coupled with the at least one memory. The one or more hardware processors are configured to execute one or more modules comprises of a transmitting module, an identification module, an analyzing module, an invocation module, and an interoperability module. The transmitting module configured to transmit at least one transaction from a first ecosystem to a second ecosystem, wherein the first ecosystem comprises a blockchain platform. The identification module configured to identify a smart contract of the blockchain platform, a set of protocols of the second ecosystem, and a format of a message of the second ecosystem. The analyzing module configured to analyze the identified smart contract, the identified set of protocols, the identified format of the message and a meta-data driven service orchestration for the transaction. An invocation module configured to invoke at least one application programming interface (API) based on the analysis of the smart contract of the first ecosystem, the set of protocols and the format of the message of the second ecosystem, and the metadata driven service orchestration for the transaction. Finally, the interoperating module configured to transmit the at least one transaction between the first ecosystem and the second ecosystem.

In yet another embodiment, a non-transitory computer readable medium storing one or more instructions which when executed by a processor on a system, cause the processor to perform method. The method provides interoperability between two or more independent ecosystems. Wherein the two or more independent ecosystems comprise of at least one of a traditional messaging network, a first blockchain platform at one end and a second blockchain platform at another end. Herein, the method comprising one or more steps of transmitting at least one transaction from a first ecosystem to a second ecosystem, wherein the first ecosystem comprises a blockchain platform, identifying a smart contract of the blockchain platform for interoperability with the second ecosystem, identifying a set of protocols of the second ecosystem to connect with the second ecosystem, identifying a format of a message of the second ecosystem to transmit to the second ecosystem, analyzing the identified smart contract, the identified set of protocols, the identified format and a meta data driven service orchestration for the transaction, invoking at least one application programming interface (API) based on the analysis of smart contract of the first ecosystem, the set of protocols and formats of the second ecosystem, and the metadata driven service orchestration for the transaction and completing the at least one transaction between the first ecosystem and the second ecosystem. Further herein, the method comprising receiving a response from the second ecosystem and processing the received response from the second ecosystem to complete the transaction within the first ecosystem.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an interoperability between two or more independent ecosystems in the block chain environment, according to some embodiments of the present disclosure;

FIG. 2 illustrates a system to provide an interoperability between two or more independent ecosystems in the block chain environment, in accordance with some embodiments of the present disclosure

FIG. 3 illustrates an architecture of the gateway, in accordance with some embodiments of the present disclosure;

FIG. 4A and FIG. 4B is a schematic architecture, wherein the gateway provides interoperability between two example ecosystems in the block chain environment, in accordance with some embodiments of the present disclosure; and

FIG. 5 is a flow diagram to illustrate a method to provide an interoperability between two or more independent ecosystems in the block chain environment, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The embodiments herein provide a method and a system to provide interoperability between two or more independent ecosystems in a blockchain environment. It would be appreciated that the system described herein, alternatively referred as a gateway which enables a communication between independent blockchain platform deployments, hence it is platform agnostic and establishes interoperability between them. It should be appreciated that the blockchain platform is alternatively referred as Distributed Ledger (DL) platform.

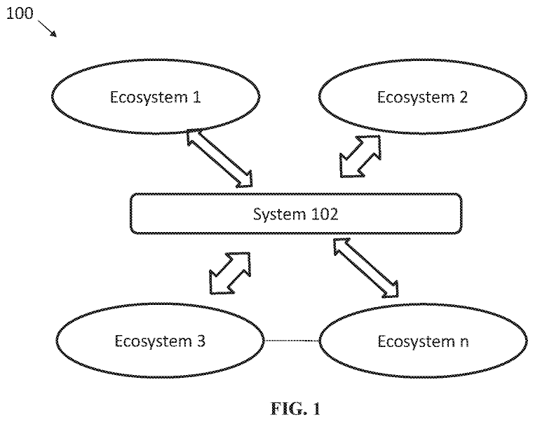

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 illustrates a blockchain environment (100) wherein a system (102) provides interoperability between two or more independent ecosystems in the block chain environment, according to some embodiments of the present disclosure. The system (102) integrates two or more ecosystems (ecosystem 1 through ecosystem n) and provides interoperability among them.

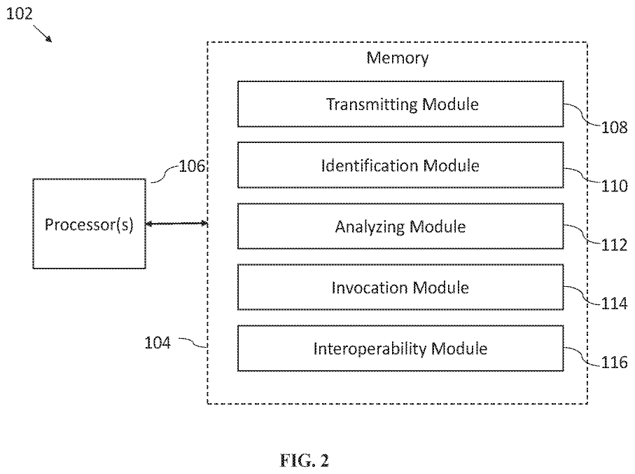

Referring FIG. 2, wherein the system (102) is configured for providing interoperability between two or more independent ecosystems. The system is configured to transmit at least one transaction from a first ecosystem to a second ecosystem, wherein the first ecosystem comprises a blockchain platform. It identifies a smart contract of the blockchain platform, a set of protocols of the second ecosystem, and a format of a message of the second ecosystem. The identified smart contract, the identified set of protocols, the identified format of the message and a meta-data driven service orchestration for the transaction are analyzed by the system. Further, the system invokes at least one application programming interface (API) based on the analysis of the smart contract of the first ecosystem, the set of protocols and the format of the message of the second ecosystem, and the metadata driven service orchestration for the transaction. Finally, the system is enabled to transmit the at least one transaction between the first ecosystem and the second ecosystem.

In the preferred embodiment, the system (102) comprises at least one memory (104) with a plurality of instructions and one or more hardware processors (106) which are communicatively coupled with the at least one memory (104) to execute modules therein.

The hardware processor (106) may be implemented as one or more microprocessors, microcomputers, microcontrollers, digital signal processors, central processing units, state machines, logic circuitries, and/or any devices that manipulate signals based on operational instructions. Among other capabilities, the hardware processor (106) is configured to fetch and execute computer-readable instructions stored in the memory (104).

In the preferred embodiment of the disclosure, a transmitting module (108) of the system (102) is configured to transmit at least one transaction from a first ecosystem to a second ecosystem. It is to be noted that the first ecosystem is a blockchain platform. The second ecosystem comprises at least one traditional messaging network or a blockchain platform which is completely independent with the blockchain platform of the first ecosystem. It would be appreciated that whenever a data is transferred across blockchain (ecosystems 1 through ecosystem n), it requires an adaptor or a channel, which provides interoperability with underlying blockchain application programming interfaces (APIs) or micro-services.

In the preferred embodiment of the disclosure, the identification module (110) of the system (102) is configured to identify a smart contract of the blockchain platform, a set of protocols of the second ecosystem, and a format of a message of the second ecosystem. The smart contract is an executable software that is stored in the platform and triggered either as a result of specific events occurring outside the platform, or as a result of pre-configured rules that are programmed into these contracts. The set of protocols comprises of a set of rules that a blockchain platform follows when it interacts by means of gateway with another blockchain platform independent of the first blockchain platform, or with the traditional messaging network. The smart contracts and the set of protocols have to be identified for the gateway to enable interoperability between multiple ecosystems in the blockchain environment

It would be appreciating that the system (102) is configured to separate a business layer and an integration layer in a blockchain solution. This separation enables business evolution to happen independent of the platform evolution and vice-versa there by either eliminating or reducing the direct impact of one-layer change/release to that of others.

In the preferred embodiment of the disclosure, the analyzing module (112) of the system (102) is configured to analyze the identified smart contract, the identified set of protocols, the identified format of the message and a metadata driven service orchestration for the transaction. The purpose of analysis is to ensure seamless connectivity between one blockchain platform to another blockchain platform or an external entity such as standard messaging systems.

The system (102) provides capability to capture metadata and business logic in a generic Manner. Further, it provides a built-in repository of factory design pattern based, DLT platform specific templates. Also enables selection of appropriate templates and populate the metadata depending on a target DLT platform. The system (102) also provides capability to translate the business logic to suit the target platform.

In the preferred embodiment of the disclosure, the invocation module (114) of the system (102) is configured to invoke at least one application programming interface (API) based on the analysis of the smart contract of the first ecosystem, the set of protocols and the format of the message of the second ecosystem, and the metadata driven service orchestration for the transaction.

It would be appreciated that the system (102) provides a generic interface to all client applications with the features including single service end points, generic structure and capability to address a particular platform (ecosystem). Further, the system (102) can handle two or more Distributed Ledger (DL) platform protocols with the help of DL platform specific APIs. The gateway has the capability to publish single Application Programming Interface (API) to two or more blockchain or DL Platforms, like HyperLedger Fabric, R3 Corda, Ethereum or the like.

In the preferred embodiment of the disclosure, the interoperability module (116) of the system (102) is configured to transmit the at least one transaction between the first ecosystem and the second ecosystem using the invoked at least one application programming interface (API).

It should be noted that the smart contracts can be written, compiled, deployed and executed in different manner on different DL platforms. The system (102) can handle each platform specific request or responses like login, logout and KeepAlive. It can also handle platform specific transformations like encoding, encryption and format conversion.

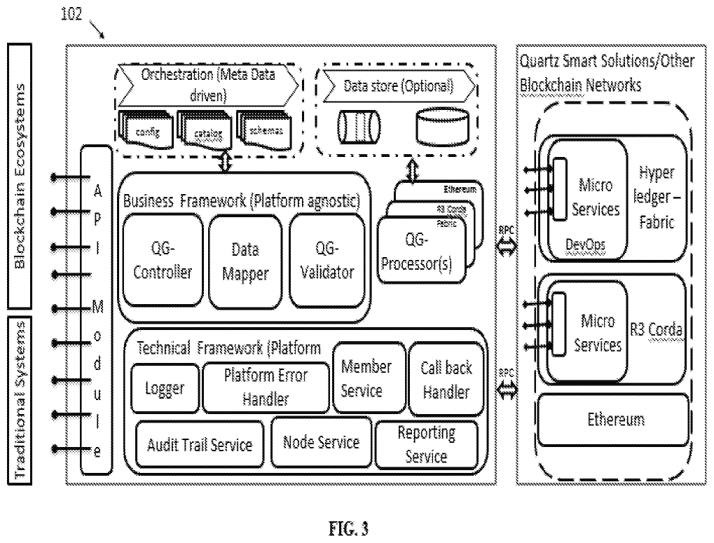

FIG. 3, an example, illustrates an architecture of the system (102) in accordance with some embodiments of the present disclosure. External ecosystems (ecosystem 1 through ecosystem n), for example Distributed Ledger (DL) applications, can be connected to one another through the system (102). The system (102) is designed to connect and operate with various DL platforms (two or more ecosystems). The system (102) can retrieve information from external DL applications. Through the system (102) transactions can be passed on to external DL applications. Further, a call back can be specified in gateway (102) to receive notification from external DL applications.

In the preferred embodiment of the disclosure, the receiving module (118) of the system (102) is configured to receive a response from the second ecosystem. The response ensures that the connection is established with the second ecosystem. Further, the response from the second ecosystem can either be a success message for publishing a data or retrieve information that can be consumed by the first ecosystem.

In the preferred embodiment of the disclosure, the processing module (120) of the system (102) is configured to process the received response from the second ecosystem to transmit the transaction within the first ecosystem.

In an example, wherein the system (102) can publish API signature to external world. A data mapper provided can convert incoming JavaScript Object Notation (JSON) to platform (ecosystem) specific JSON object(s). Further, the platform specific micro services may be called in the required sequence to accomplish a business process. Metadata configuration may be made available to map incoming DL API to external DL API. The signature of this API is a JSON object. In the system (102), the JSON object has three major sections including header, payload and access policy. Further, transfer of data can be done from one blockchain ecosystem (for example, ecosystem 1) to another blockchain ecosystem (for example, ecosystem 2). Thus, the system (102) provides a generic interface to all client applications with the features including single service end points, generic structure and capability to address a particular platform (ecosystem).

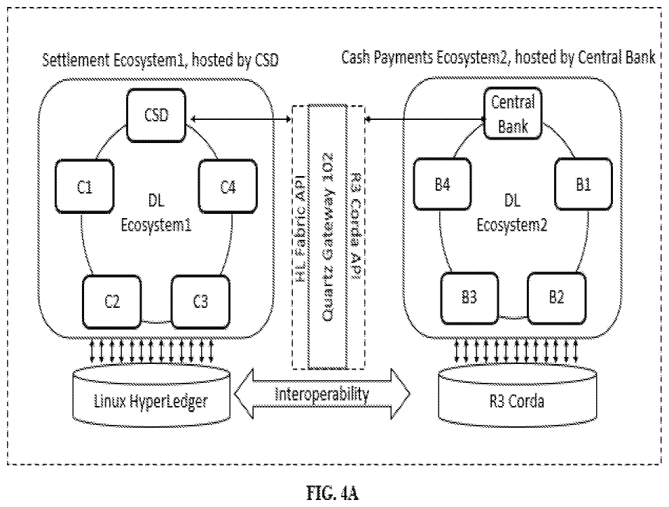

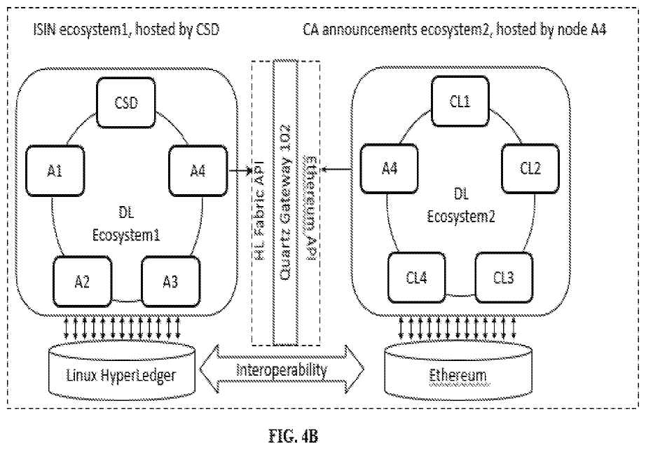

Referring FIG. 4A and FIG. 4B, another example, wherein the system (102) provides interoperability between two blockchain ecosystems in the block chain environment 100, in accordance with some embodiments of the present disclosure.

As depicted in FIG. 4A, a transaction needs to be completed in two ledgers and hence invoking of the transaction from DL with Linux Hyperledger Fabric (ecosystem 1) to another DL with R3 Corda (ecosystem 2) to complete a business process. The system (102) facilitates the transaction between to different ecosystems as explained in conjunction with FIG. 3. In the example of FIG. 2A, a Delivery versus Payment (DvP) transactions has two parts including a security settlement and funds settlement. The security settlement should be completed in a blockchain for securities provided by say a Central Securities Depository (CSD), which deploys ecosystem 1 based on Linux ledger. The cash is to be settled in funds ledger provided by a central bank, which deploys ecosystem 2 based on R3 Corda. The system (102) provides interoperability by providing a mechanism to transfer the data from one ecosystem to another and orchestrate the completion of the transaction. Further, for completion of the transaction in the DL ledger, a smart contract might require a data from one other ledger. The system (102) can again facilitate the same. The steps performed for transaction between the CSD (deploying ecosystem 1) and the central bank (deploying ecosystem 2) for DvP Settlement instruction are provided below.

STEP 1: On the CSD side (ecosystem 1/DL1), where C1 is the buyer, C4 is a seller the CSD performs security earmarking for C4 and the CSD initiates cash payment from C1 to C4. This is handed over with the bank information and the transaction details to the other DL (central bank deploying ecosystem 2).

STEP 2: On Central bank side (ecosystem 2/DL2), the central bank node receives the cash payment instruction, related to the settlement instruction from ecosystem 1. The request is verified and authorized by the smart contract at ecosystem 2, where B1 node represents the bank of C1 and B4 node represents bank for C4. Cash payment is performed from B1 to B4. Central Bank node hands over payment confirmation to CSD.

STEP 3: On CSD node in ecosystem 1, the CSD receives successful cash payment information. Earmarked securities of C4 are moved to C1, completing settlement in the DL.

The FIG. 4B explains that where information on one DL is used by other DL for processing. The International Securities Identification Number (ISIN) dissemination and validation for Company Announcements (CA) is carried out, wherein ISIN ecosystem 1 is hosted by the CSD and the CA announcements ecosystem 2 is hosted by A4.

STEP 1: On DL1 (Linux Hyperlegder (HL) ecosystem 1 deployed by the CSD): Information of the ISIN ecosystem 1 hosted by CSD is pushed by the CSD onto the DL1. Other nodes also receive ISIN information. The A4 is also connected as a node in DL2.

STEP 2: On DL2 (Ehereum ecosystem 2 deployed by the A4): The A4 shares the CA announcements to its customers, who are connected to the DL. Further, the A4 receives ISIN information from DL1. A4 uses this to validate a CA announcement. After successful validation, A4 pushes the CA announcement into the DL (DL2). All other nodes connected to DL2 receive the CA announcement information for this ISIN.

It should be appreciated that the system (102) may be a web service-based interface and it can handle two or more Distributed Ledger (DL) platform protocols with the help of DL specific adapters. The system (102) has the capability to publish single Application Programming Interface (API) to two or more DL Platforms, like Hyperledger Fabric, R3 Corda, Ethereum or the like.

It would also be appreciated that the smart contracts of the blockchain platforms can be written, compiled, deployed and executed in different manner on different DL platforms. The system (102) can handle platform specific request or responses like login, logout and KeepAlive. It can also handle platform specific transformations like encoding, encryption and format conversion. In specific scenarios system (102) is designed to enable the business to implement a large use case that may span across two or more blockchain platform services.

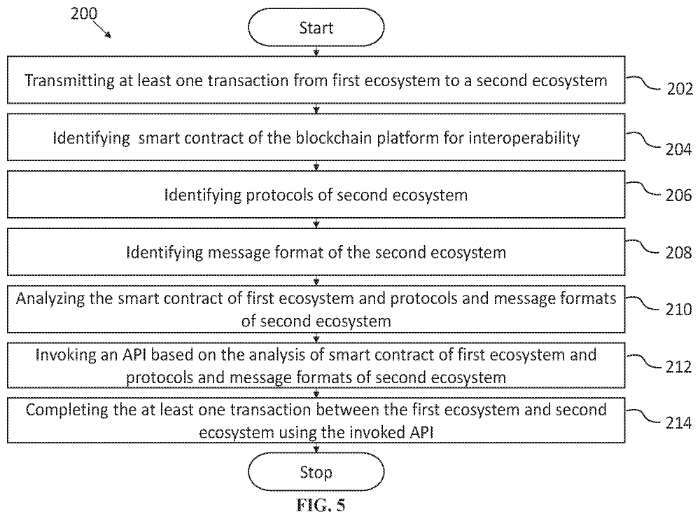

Referring FIG. 5, a processor-implemented method (200) to provide interoperability between two or more independent ecosystems. The method comprises one or more steps as follows. Initially, it transmits at least one transaction from a first ecosystem to a second ecosystem, wherein the first ecosystem comprises a blockchain platform. It identifies a smart contract of the blockchain platform, a set of protocols of the second ecosystem, and a format of a message of the second ecosystem. The identified smart contract, the identified set of protocols, the identified format of the message and a meta-data driven service orchestration for the transaction are analyzed by the system. Further, it invokes at least one application programming interface (API) based on the analysis of the smart contract of the first ecosystem, the set of protocols and the format of the message of the second ecosystem, and the metadata driven service orchestration for the transaction. Finally, it enabled to transmit the at least one transaction between the first ecosystem and the second ecosystem.

Initially, at the step (202), at least one transaction is transmitted from a first ecosystem to a second ecosystem. It is to be noted that the first ecosystem is a blockchain platform. The second ecosystem comprises at least one traditional messaging network or a blockchain platform which is completely independent with the blockchain platform of the first ecosystem.

In the preferred embodiment of the disclosure, at the next step (204), a smart contract of the blockchain platform, a set of protocols of the second ecosystem, and a format of a message of the second ecosystem are identified at an identification module (110) of the system (102).

In the preferred embodiment of the disclosure, at the next step (206), analyzing the identified smart contract, the identified set of protocols, the identified format of the message and a meta-data driven service orchestration for the transaction at an analyzing module (112) of the system (102).

In the preferred embodiment of the disclosure, at the next step (208), invoking at least one application programming interface (API) based on the analysis of the smart contract of the first ecosystem, the set of protocols and the format of the message of the second ecosystem, and the metadata driven service orchestration for the transaction at an invocation module (114) of the system (102).

In the preferred embodiment of the disclosure, at the last step (210), the at least transaction between the first ecosystem and the second ecosystem is done at an interoperability module of the system using the invoked at least one application programming interface (API).

In another embodiment, the processor-implemented method (200) comprising at step (212) receiving a response from the second ecosystem at a receiving module (120) of the system.

In yet another embodiment, the processor-implemented method (200) comprising at step (214) processing the received response from the second ecosystem at a processing module (120) of the system (102) to transmit the transaction within the first ecosystem.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address unresolved problem of business to interoperate between heterogeneous blockchain platforms based on suitability to a business process and availability of the ecosystem or regional dominance. Embodiments herein provide, a method and system to provide interoperability between two or more independent ecosystems in a block chain environment.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means, and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method to provide interoperability between two or more independent ecosystems, the method comprising one or more steps of:
transmitting at least one transaction from a first ecosystem to a second ecosystem, wherein the first ecosystem comprises a blockchain platform;
identifying a smart contract of the blockchain platform for interoperability with the second ecosystem;
identifying a set of protocols of the second ecosystem to connect with the second ecosystem;
identifying a format of a message of the second ecosystem to transmit to the second ecosystem;
analyzing the identified smart contract, the identified set of protocols, the identified format and a meta data driven service orchestration for the transaction;
invoking at least one application programming interface (API) based on the analysis of smart contract of the first ecosystem, the set of protocols and formats of the second ecosystem, and the metadata driven service orchestration for the transaction; and
completing the at least one transaction between the first ecosystem and the second ecosystem using the invoked at least one application programming interface (API).

2. The method claimed in claim 1, further comprising:
receiving a response from the second ecosystem; and
processing the received response from the second ecosystem to complete the transaction within the first ecosystem.

3. The method claimed in claim 1, wherein the second ecosystem comprises of a traditional messaging network or a blockchain platform, wherein the blockchain platform of second ecosystem is independent to the blockchain platform of the first ecosystem.

4. The method claimed in claim 1, wherein the traditional messaging network comprises of traditional messaging formats, wherein the traditional messaging formats comprises of SWIFT ISO 15022/ISO 20222/FIX/FIXML.

5. The method claimed in claim 1, wherein the smart contract comprises of business rules deployed in the blockchain platform.

6. A system to provide interoperability between two or more independent ecosystems, wherein the system comprising:
at least one memory storing a plurality of instructions;
one or more hardware processors communicatively coupled with the at least one memory, wherein the one or more hardware processors are configured to execute one or more modules;
a transmitting module configured to transmit at least one transaction from a first ecosystem to a second ecosystem, wherein the first ecosystem comprises a blockchain platform;
an identification module configured to identify a smart contract of the blockchain platform, a set of protocols of the second ecosystem, and a format of a message of the second ecosystem;
an analyzing module configured to analyze the identified smart contract, the identified set of protocols, the identified format of the message and a meta data driven service orchestration for the transaction;
an invocation module configured to invoke at least one application programming interface (API) based on the analysis of the smart contract of the first ecosystem, the set of protocols and the format of the message of the second ecosystem, and the metadata driven service orchestration for the transaction; and
an interoperating module configured to transmit the at least one transaction between the first ecosystem and the second ecosystem using the invoked at least one application programming interface (API).

7. The system claimed in claim 6, further comprising:
a receiving module configured to receive a response from the second ecosystem; and
a processing module configured to process the received response from the second ecosystem to transmit the transaction within the first ecosystem.

8. The system claimed in claim 6, wherein the second ecosystem comprises of a traditional messaging network or a blockchain platform, wherein the blockchain platform of second ecosystem is independent to the blockchain platform of the first ecosystem.

9. The system claimed in claim 6, wherein the set of protocols of the second ecosystem comprises of traditional messaging formats, wherein the traditional messaging formats comprises of SWIFT ISO 15022/ISO 20222/FIX/FIXML or another blockchain platform independent of the first blockchain platform.

10. The system claimed in claim 6, wherein the smart contract comprises of business rules deployed in the blockchain platform.

11. A non-transitory computer readable medium storing one or more instructions which when executed by a processor on a system, cause the processor to perform method comprising:
transmitting, via one or more hardware processors, at least one transaction from a first ecosystem to a second ecosystem, wherein the first ecosystem comprises a blockchain platform;
identifying, via one or more hardware processors, a smart contract of the blockchain platform for interoperability with the second ecosystem;
identifying, via one or more hardware processors, a set of protocols of the second ecosystem to connect with the second ecosystem;
identifying, via one or more hardware processors, a format of a message of the second ecosystem to transmit to the second ecosystem;
analyzing, via one or more hardware processors, the identified smart contract, the identified set of protocols, the identified format and a meta data driven service orchestration for the transaction;
invoking, via one or more hardware processors, at least one application programming interface (API) based on the analysis of smart contract of the first ecosystem, the set of protocols and formats of the second ecosystem, and the metadata driven service orchestration for the transaction; and
completing, via one or more hardware processors, the at least one transaction between the first ecosystem and the second ecosystem using the invoked at least one application programming interface (API).
